(19) United States
(12) Patent Application Publication
(10) Pub. No.: US 2020/0408883 A1
(43) Pub. Date: Dec. 31, 2020

(54) LIDAR DEVICE FOR SITUATION-DEPENDENT SCANNING OF SOLID ANGLES

(71) Applicant: Robert Bosch GmbH, Stuttgart (DE)

(72) Inventors: Annette Frederiksen, Renningen (DE); Axel Buettner, Stuttgart (DE)

(21) Appl. No.: 16/629,441

(22) PCT Filed: Jun. 4, 2018
(86) PCT No.: PCT/EP2018/064548

§ 371 Date: Mar. 25, 2020

(30) Foreign Application Priority Data
Jul. 11, 2017 (DE) 10 2017 211 817.2

(51) Int. Cl. G01S 7/481

(52) U.S. Cl. CPC G01S 7/4815; G01S 17/931; G01S 7/4817

(57) ABSTRACT

A lidar device for scanning solid angles with at least one beam, having at least one beam source configured so as to be capable of horizontal rotation for producing at least one beam, having at least one beam emitter for forming the at least one produced beam, having a beam collector capable of horizontal rotation for receiving at least one beam reflected by an object and for deflecting the at least one reflected beam onto a detector, the at least one produced beam being capable of being formed in a variable manner.

### FIELD OF THE INVENTION

The present invention relates to a lidar (Light Detection and Ranging) device for scanning solid angles with at least one beam, having at least one beam source, configured so as to be capable of horizontal rotation, for producing at least one beam, having at least one beam emitter for forming the at least one produced beam, having at least one beam collector, capable of being rotated horizontally, for receiving at least one beam reflected by an object and for deflecting the at least one reflected beam to a detector.

### BACKGROUND INFORMATION

Standard lidar devices are based on various configurations. On the one hand, so-called microscanners, and on the other hand macroscanners, may be used. In macroscanners, a transmit unit and a receive unit can be situated on a rotor and can rotate or pivot together about an axis of rotation. In this way, for example a horizontal scan angle of 360° can be illuminated and scanned.

From DE 10 2006 049 935 A1, a lidar device, or a macroscanner, is discussed that uses a focused individual beam to scan a scanning region, and assesses and evaluates reflected beams in the context of a signal processing.

Such lidar devices standardly have a limited vertical resolution and a relatively small vertical scan angle that cannot be modified in a situation-dependent manner.

### SUMMARY OF THE INVENTION

An underlying object of the present invention may be regarded as providing a lidar device that can adapt an illumination of solid angles in a situation-dependent manner.

This object may be achieved by the respective subject matter of the embodiments described herein. Advantageous embodiments of the present invention are the subject matter of the respective further descriptions herein.

According to an aspect of the present invention, a lidar device for scanning solid angles with at least one beam is provided. The lidar device has at least one beam source, configured so as to be capable of horizontal rotation, for producing at least one beam. A beam emitter is used to form the at least one produced beam. The beam emitter can be made up of a plurality of optical elements, such as lenses, diffractive optical elements, holographic optical elements, and the like. In addition, the lidar device has a beam collector capable of being rotated horizontally that receives at least one beam reflected by an object and deflects it onto a detector.

The beam source can form, together with the beam emitter or a part of the beam emitter, a transmit unit. The beam source can be for example an infrared semiconductor laser, a laser bar, and the like. The beam source can thus produce electromagnetic beams continuously or in pulsed manner.

A receive unit is made up of a beam collector and the detector. The detector can be for example a column detector divided into detector pixels. The detector can be a single-photon avalanche diode, or SPAD. Due to high sensitivity, the SPAD detector can enable a high resolution in low illumination, using time-correlated single-photon counting, or TCSPC. In this way, a vertical resolution of the lidar device can be improved at the detector side.

The transmit unit and the receive unit can rotate horizontally synchronously with one another, and in this way can illuminate and detect a horizontal scan angle. The transmit unit and the receive unit can be operated temporally both in parallel and in series. For example, the transmit unit and the receive unit can be situated alongside one another so as to be capable of rotation, or can be situated axially to one another along an axis of rotation.

The transmit unit can produce one or more beams that run vertically one over the other, which define and illuminate a vertical scan angle. A vertical resolution of the lidar device can subsequently be realized by the column detector.

The beam emitter is used for the forming of the at least one produced beam and has at least one modifiable lens that can adapt or modify the at least one produced beam. Through a beam emitter that is variable in this way, for example a focus and/or a direction of deflection can be modified at the transmit side. The beam emitter may be configured so as to be capable of being rotated both as a whole with the beam source, and also so as to be partly rotatable and partly stationary. Thus, beams produced by the beam source can be influenced and variably formed in such a way that the lidar device can be adapted optimally to particular environments, speeds, orientations, and the like. In such a lidar device, the vertical resolution and/or the range can be varied for example in a situation-dependent manner. For example, a vertical scan angle can be reduced by stronger focusing, and the range of a scan region can be increased. On the other hand, a vertical scan angle can be enlarged, with simultaneously smaller range, or a vertical scan angle can be axially displaced or offset. In this way, for example in a vehicle, the edge regions can be scanned by the lidar device with a lower resolution by the detector and with a larger vertical scan angle. For this purpose, in the detector for example every second or every third detector pixel can be used for evaluation. In the direction of travel, in contrast, a large range, with a small vertical scan angle, may be appropriate and capable of being realized. The illumination of the lidar device can be varied in a situation-dependent manner. For example, the illumination can be adapted to uphill travel, downhill travel, travel on a rural roadway, highway travel, city travel, and the like. The beam emitter can also be made up of a plurality of modifiable and non-modifiable lenses and/or optical elements.

In addition, the lidar device can enable changing over between various illumination states, such as to a larger vertical scan angle for a large-surface coverage of a near-field environment, and can thus be used for localization in complex environments. Modifiable lenses, based on electroactive polymers, can for example be used as a variable lens or adaptive optical system.

According to an exemplary embodiment of the lidar device, the beam source has individual emitters, and produces at least two beams that have an angular offset or local offset to one another vertically. The beam source can for example be a laser bar having a multiplicity of individual emitters. Each emitter can thus produce at least one electromagnetic beam. Alternatively, for example a plurality of semiconductor lasers can be configured alongside one another. In particular in the case of a configuration of the emitters in series, the beam source can realize a pixel-by-pixel, or punctiform, or a linear vertical illumination of the scan region. In this way, the vertical scan region can be illuminated partly or completely by the produced beams.

According to a further exemplary embodiment of the lidar device, the at least one beam can be focused in radially variable manner. The modifiable lens of the beam emitter can modify its focal length, and can thus focus at least one produced beam in a focal plane, for example in punctiform manner. The radial distance of the focal plane from the lidar device can be influenced and set by the modifiable lens.

According to a further exemplary embodiment of the lidar device, the at least one beam can be focused in axially variable manner. The modifiable lens can in particular be modified in its shape. In this way, the at least one produced beam can be axially deflected or offset. In this way, for example a vertical scan angle can be realized that runs higher or lower. In this way, for example given an automotive application of the lidar device, when traveling on a hill a height and a position of the vertical scan region can be actively modified.

According to a further exemplary embodiment of the lidar device, the at least one beam can be variably shaped in time-dependent manner. With the aid of the at least one modifiable lens, the at least one produced beam can be modified at the transmit side in such a way that, for example upon every second rotation of the transmit unit, the produced beams are modified or a changeover takes place between two or more defined illumination modes. Alternatively or in addition, an adaptation of the produced beams can also take place within a rotation of the transmit unit.

According to a further exemplary embodiment of the lidar device, the at least one beam can be variably shaped as a function of a rotational position of the beam source. In this way, the at least one produced beam can be adapted or varied at least once within a rotation of the transmit unit. Thus, for example a lidar device situated on the roof of a vehicle, given a rotational position in the direction of the front of the vehicle during travel, can focus the produced beams as far as possible from the lidar device, and in this way can enable a maximum range of the illumination. At the vehicle edges, the produced beams can have the largest possible vertical scan angle, with a comparatively small range of the lidar device. During a parking process, the produced beams can be limited to a small range along the entire rotation of the transmit unit. Thus, a horizontal scan angle of 360° can be divided into a plurality of angular segments. Within the respective angular segments, the at least one produced beam can thus be constant or can be varied or modified.

According to a further exemplary embodiment of the lidar device, the beam source produces at least one beam that has an angular offset or a local offset, in a time-dependent manner. Alternatively or in addition to a controlling of the resolution by the detector, by using a limited number of detector pixels for the further evaluation, an illumination can be adapted by the beam source. For example, all emitters of the beam source can be activated, or only a defined portion of all the emitters can be activated. Alternatively, each second or third emitter of the beam source may also be activated. In applications having maximum required range, all emitters can be activated. In applications having a lower requirement for the maximum distance, an intensity of the illumination can be reduced through fewer active emitters. In this way, it can for example be prevented that the detector experiences saturation or overexposure when objects in the near range are illuminated.

According to a further exemplary embodiment of the lidar device, the beam source produces at least one beam having an angular offset or a local offset as a function of a rotational position of the beam source. The adaptation of the beam power, by switching on or switching off emitters of the beam source, can be realized in time-dependent manner or based on a rotational position of the beam source or of the transmit unit. The horizontal scan angle can in this way be divided into a plurality of angular regions having different functions. This enables for example a more comprehensive measurement of an environment close to the vehicle, which may be required for various functions of an environmental recognition system for automated driving. In this way, for example a recognition of a roadway boundary can be optimized, or a drivable surface can be better assessed. In this way, a localization of the lidar device can be enabled even in complex environments, because the lidar device can scan particular unrecognized, or wrongly recognized, regions of the environment multiple times using differently formed beams in order to gain more information about a solid angle.

According to a further exemplary embodiment of the lidar device, the beam emitter has at least one passive optical element. In addition to non-modifiable lenses, the beam emitter can have optical elements that are configured so as to be non-rotatable. These optical elements may be other lenses, filters, different active optical elements, such as volume-holographic optical elements, and the like. The optical elements can be situated for example on a housing of the lidar device. Within a complete or partial horizontal scan region and/or vertical scan angle, in this way at least one optical element is situated in a beam path of the produced beam, and can thus form the at least one produced beam before the at least one produced beam is emitted to the solid angle to be scanned. Such a passive optical element is part of the beam emitter, and can be realized for example in the form of a film that is configured in stationary manner around the circumference of the transmit unit. In this way, different regions of the solid angle to be scanned can be illuminated and scanned in adapted manner. Here, an active controlling can be omitted, thus simplifying such a lidar device.

According to a further exemplary embodiment of the lidar device, the at least one beam can be formed by the at least one passive optical element as a function of a rotational position of the beam source. Here, the transmit unit can be situated axially on a different plane from the receive unit. Thus, the transmit unit can conduct at least one produced beam through at least one passive optical element, at least partially along its horizontal rotation. The passive optical elements can be configured continuously or only within particular rotational positions. The passive optical elements can for example be laminated or glued onto an inner side of an emission window of the lidar device. The passive optical elements can be spatially separated from one another, or can go over into one another seamlessly or gradually.

According to a further advantageous exemplary embodiment of the lidar device, the at least one passive optical element is a holographic optical element. The passive optical elements are advantageously realized as holographic optical elements. In particular, the holographic optical elements can be volume holograms. In contrast to conventional optical systems, in holographic optical elements realized as volume holograms the beam deflection is not specified by refraction, but by diffraction at the volume grating. The holographic optical elements can be made both in transmission and in reflection, and enable a free choice of the angle of incidence and of reflection or diffraction. In order to produce a holographic optical element, a holographic material can be applied onto a bearer film and subsequently exposed in an exposure process so that the optical function is embedded into the material. This exposure method can be analogously, for example, printed pixel-by-pixel. Due to a volume diffraction at the volume hologram, the holographic optical element additionally has a characteristic wavelength and angular selectivity, or also a filtering function.

According to a further exemplary embodiment of the lidar device, the beam emitter has at least one modifiable optical system. The modifiable, or adaptive, optical system can in particular be a liquid lens, and can be a part of the beam emitter. Such lenses can vary their focal length as a function of an applied voltage. This function can for example be based on the principle of electrowetting. With a liquid lens, not only is a variable focusing possible, but also a beam deflection, or beam offset, in the vertical or axial direction, or in the horizontal direction.

In the following, exemplary embodiments of the present invention are explained in more detail on the basis of highly simplified schematic representations.

In the Figures, the same constructive elements each have the same reference characters.

### BRIEF DESCRIPTION OF THE DRAWINGS

FIG. 1 shows a schematic representation of a lidar device according to a first exemplary embodiment.

FIG. 2a shows a schematic representation of a transmit unit of a lidar device according to a second exemplary embodiment.

FIG. 2b shows a schematic representation of a transmit unit of a lidar device according to a third exemplary embodiment.

FIG. 3a shows a schematic representation of a lidar device according to a fourth exemplary embodiment.

FIG. 3b shows a schematic top view of a passive optical element of the lidar device according to the fourth exemplary embodiment.

### DETAILED DESCRIPTION

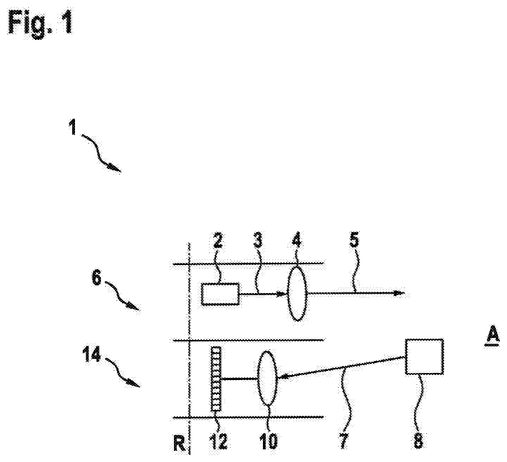

FIG. 1 shows a schematic representation of a lidar device 1 according to a first exemplary embodiment. Lidar device 1 has a beam source 2. According to this exemplary embodiment, beam source 2 can for example be a semiconductor laser 2 that can produce laser beams 3. The produced beams 3 can subsequently be formed or adapted by a beam emitter 4. The formed beams 5 are then emitted by lidar device 1 in the direction of a solid angle A. Beam emitter 4 is a liquid lens 4 that can be supplied with electrical voltage via electrical connections (not shown), and can thus modify their optical properties in voltage-dependent manner. Beam source 2 and the beam emitter together form a transmit unit 6.

If objects 8 are situated in solid angle A, the shaped beams 5 can be reflected or scattered by objects 8. The scattered or reflected beams 7 can be received by a beam collector 10 and deflected onto a detector 12. Detector 12 is a column detector made up of a multiplicity of detector pixels that are configured in a row and that define a vertical resolution of lidar device 1. Detector 12 and beam collector 10 here form a receive unit 14 of lidar device 1.

Transmit unit 6 and receive unit 14 are capable of rotation horizontally by 360° about an axis of rotation R, and are configured axially one over the other.

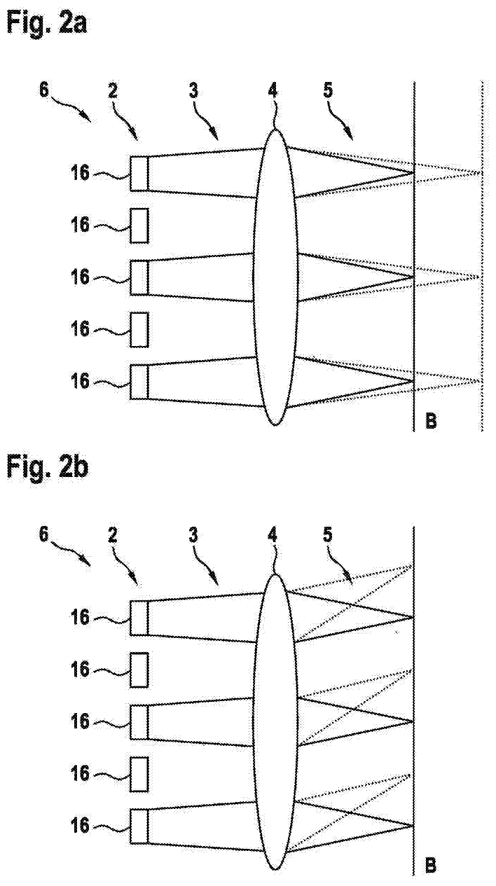

In FIGS. 2a and 2b, schematically representations are shown of transmit units 6 of a lidar device 1 according to a second and a third exemplary embodiment. Here, beam sources 2 are each realized as laser bars 2, each having five individual emitters 16. A use of beam source 2 is shown with a reduced number of activated emitters 16. According to the exemplary embodiment, three of the five individual emitters 16 of beam source 2 are activated, and thus produce beams 3. The produced beams 3 are varied, or adapted, by liquid lens 4. The formed beams 5 have a common focal plane B and are realized in focal plane B for example in punctiform manner. The respective produced beams 3 can also be united by beam emitter 4 to form a linear beam in focal plane B. Beam emitter 4, or the at least one liquid lens 4 of the beam emitter, can bundle the produced beams 3 with different strengths, as a function of an applied voltage, so that focal plane B of the formed beams 5 can be displaced. Alternatively or in addition, the formed beams 5 can be deflected in a vertical or axial, or horizontal, direction as a function of a further applied voltage, and can thus locally offset their focal points within focal plane B. The dotted beam paths illustrate the effects of liquid lens 4 on the produced beams 3.

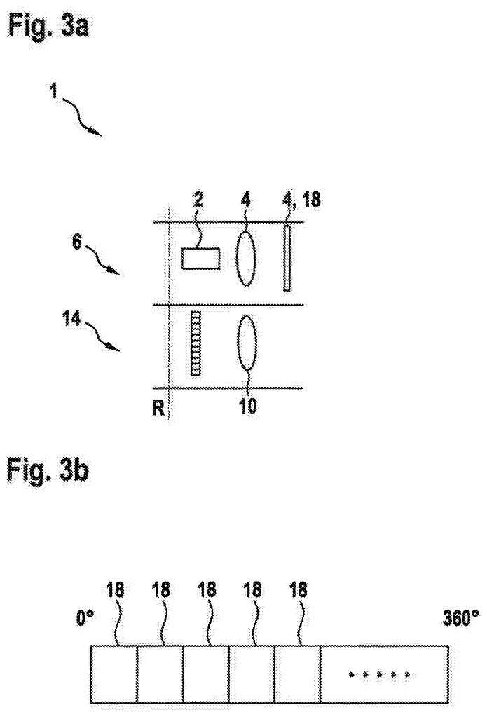

FIG. 3 shows a schematic representation of a lidar device 1 according to a fourth exemplary embodiment. Differing from lidar device 1 according to the first exemplary embodiment, lidar device 1 here has a beam emitter 4 having a passive optical element 18. Here, beam emitter 4 can have modifiable lenses 4 and also non-modifiable lenses. Here, passive optical element 18 is a volume hologram 18 realized as a film. The film is disposed in stationary manner around the circumference of the rotatable transmit unit 6. During a rotation of transmit unit 6 about axis of rotation R, all regions of the film are thus exposed one after the other. The different regions of the film are made up of different volume holograms 18 that have different or the same optical functions. FIG. 3b shows such a film in a spread-out state. An angular region of from 0° to 360°, with various rectangular volume holograms 18, of the film is shown. After a forming by lens 4, produced beams 3 are thus additionally formed or filtered by the respective volume holograms 18 as a function of a horizontal rotational position of transmit unit 6.

1-12. (canceled)

13. A lidar device for scanning solid angles with at least one beam, comprising:
at least one beam source, which is horizontally rotatable, for producing at least one beam;
at least one beam emitter for forming the at least one produced beam; and
a beam collector, which is horizontally rotatable, for receiving at least one beam reflected by an object and for deflecting the at least one reflected beam onto a detector;
wherein the at least one produced beam is formable in a variable manner.

14. The lidar device of claim 13, wherein the beam source includes individual emitters and is configured to produce at least two beams having an angular offset or a local offset vertically to one another.

15. The lidar device of claim 13, wherein the at least one produced beam is focusable in a radially variable manner.

16. The lidar device of claim 13, wherein the at least one produced beam is focusable in an axially variable manner.

17. The lidar device of claim 13, wherein the at least one produced beam is variably formable as a function of time.

18. The lidar device of claim 13, wherein the at least one produced beam is variably formable as a function of a rotational position of the beam source.

19. The lidar device of claim 13, wherein the beam source is configured to produce, as a function of time, at least one beam having an angular offset or a local offset.

20. The lidar device of claim 13, wherein the beam source is configured to produce at least one beam having an angular offset or a local offset as a function of a rotational position of the beam source.

21. The lidar device of claim 13, wherein the beam emitter includes at least one passive optical element.

22. The lidar device of claim 21, wherein the at least one produced beam is formable by the at least one passive optical element as a function of a rotational position of the beam source.

23. The lidar device of claim 21, wherein the at least one passive optical element includes a holographic optical element.

24. The lidar device of claim 13, wherein the beam emitter includes at least one modifiable optical system.
